(19) United States
(12) Patent Application Publication
(10) Pub. No.: US 2004/0173113 A1
(43) Pub. Date: Sep. 9, 2004

(54) Quality control device

(76) Inventors: Reinhold Dunninger, Wurzburg (DE); Gerald Josef Reinhard, Sulzfeld (DE)

Correspondence Address: Douglas R Hanscom, Jones Tullar & Cooper, Eads Station, PO Box 2266, Arlington, VA, 22202, US

(21) Appl. No.: 10/479,981

(22) PCT Filed: Jun. 6, 2002
(86) PCT No.: PCT/DE02/02042

(30) Foreign Application Priority Data
Jun. 15, 2001 (DE) 10128833.6

(51) Int. Cl. B41F 21/08; B41F 33/00

(52) U.S. Cl. 101/408; 101/484

(57) ABSTRACT

The invention relates to a quality control device (06), comprising a suction box (07), at least one gripper (22) displaced along a suction surface (19) of the suction box and used to draw the sheet (21) across the suction box, and a CCD camera (08). On the suction surface of the suction box a belt (18) that is displaced in the sheet transport direction (13) of the sheet is disposed

The invention relates to a quality control device in accordance with the preambles of claims 1 or 2.

Such a quality control device is known from EP 0 527 453 B1. Quality control devices of this type are employed in connection with printing presses for taking images of the imprinted sheets and for detecting deviations from a desired print quality by comparing these sheets with a desired printed image and to be able to intervene correctively in the printing process when required.

For this purpose the known device has a suction box with a suction surface, over which the imprinted sheets are pulled with the aid of sheet grippers. Because of the frictional contact of the sheets with the suction surface of the suction box it is assured that the sheets are always tightly stretched and lie on a well-defined level so that it is possible to obtain a true image of the sheet with the aid of a camera facing the suction surface.

If such a device is employed for the quality control of sheets imprinted on both sides, there is the danger that ink is smeared over the surface of the sheet which is not controlled and faces the suction box.

A device for quality control which addresses this problem is described in DE 44 36 583 A1. This device is comprised of a drum charged with a partial vacuum and a line camera facing the jacket of the drum. A gripper pulls the sheets to be controlled through the space between the line camera and the drum, where the sheets rest on the drum as a result of the partial vacuum. The path of the sheets through the quality control device is approximately straight. However, the suction effect by the drum causes each of the sheets to be controlled to adhere on a section of the drum in the shape of a segment of a circle, wherein the extension of this section cannot be exactly controlled. It is a function of the stiffness of the sheets to be controlled and of the suction force exerted by the drum and does not remain constant during the movement of a sheet over the drum. This has the result that, even if the speed of the gripper is exactly constant, the speed of that part of the surface of the sheet to be controlled which touches the drum and lies within the field of view of the line camera, is subject to fluctuations in an uncontrolled manner. Since these fluctuations are not being taken into consideration in the course of the image capture by the line camera, non-reproducible variations of the results of the image-taking result. If these fluctuations are not to result in that good sheets are removed as waste, the comparison with the desired print image must be “tolerant”, so that there is the danger that errors actually present in the print image are overlooked.

A suction conveyor for use in a sheet-fed printing press is known from EP 0 798 251 A2, which is comprised of a suction box with a circulating driven belt. This suction box is employed for conveying the sheets at the start or the end of processing in the printing press at locations where sheet grippers conducting the sheets between the various stations of the printing process have either not yet gripped them or have already released them.

However, in this case the suction conveyor is used as the sole conveying means for the sheets, while with the present invention the suction belt employed is exclusively used for stabilizing—but not conveying—the sheets conveyed by a separate chain gripper system for the purpose of quality control.

DE 42 39 561 A1 discloses a sheet conveying arrangement wherein the start of the sheet is transported by means of a chain gripper and the imprinted underside simultaneously rests on a moving suction belt. Nothing can be found regarding the type of a drive mechanism and the speed of the suction belt.

The object of the invention is based on providing a quality control device.

In accordance with the invention, this object is attained by means of the characteristics of claims 1 or 2.

The suction box is required for being able to conduct a sheet whose quality is to be checked through the field of view of the monitoring camera without any chronologically changeable curvature. Smearing of ink because of the friction between the surface of the suction box and the back of the sheet is prevented in that, instead of the suction box surface, a belt, which can be moved together with the sheet, is in contact with the latter.

A planar camera is preferably used as the camera, so that a complete image can be taken at a given time, and local interferences with even running of the conveyance of the sheet cannot lead to errors in taking the images.

In connection with a simple but effective embodiment of the control device it is provided that the belt is being driven by the same chain which also guides the sheet gripper. In this way it is possible to achieve the synchronous running of the belt and the sheet grippers without an elaborate control mechanism.

A first option for coupling the belt with the chain is the use of a chain wheel which is engaged by the chain and is connected, fixed against relative rotation, via a chain or toothed belt drive mechanism with a roller guiding the belt.

With an appropriate layout of the pitch circle diameter of the chain wheel, of the drive transmission, as well as of the exterior diameter of the belt roller, the speed of the belt corresponds exactly to that of the chain. Thus, while being conveyed over the suction surface of the suction box, a sheet pulled by a gripper remains at rest in relation to the belt, so that smearing is prevented. The pitch circle of the chain wheel, or the drive transmission can also be slightly greater, so that the speed of the belt is slightly less than that of the gripper. By means of this it is assured that the sheet rests tightly pulled and level on the belt when the camera takes a picture. The difference between the speeds of the sheet and the belt can be of an order of magnitude of a few percent; in every case the relative displacement of the sheet and the belt in respect to each other in the course of the movement of the sheet over the suction box is substantially less than the movement of the sheet in relation to the suction box, so that the danger of smearing is also clearly reduced even at different speeds.

A more flexible control is possible if, in accordance with a second preferred embodiment, the belt is driven by its own drive motor. The latter can also be regulated in such a way that the track speed of the gripper corresponds to that of the belt, or at most is slightly greater. In this case the option is particularly advantageous wherein the track speed is regulated in accordance with the pulling force exerted by the gripper on the sheet in such a way that there is a pulling force, i.e. that the sheet is tensed, but that on the other hand a threshold value of the pulling force which could result in the sliding of the sheet over the belt, is not exceeded.

Exemplary embodiments of the invention are represented in the drawings and will be described in greater detail in what follows.

Shown are in:

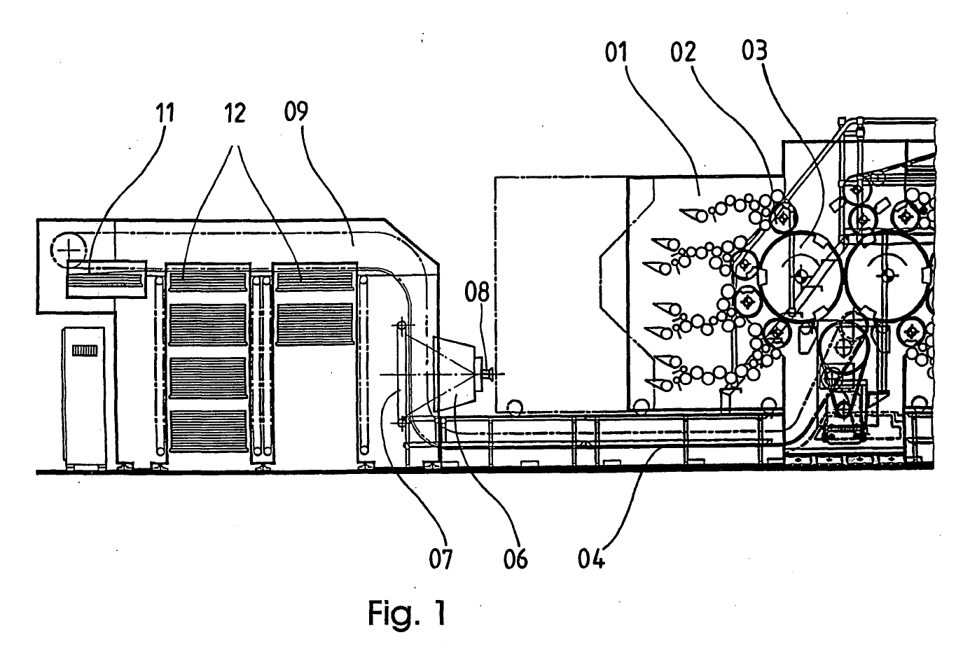

FIG. 1, a schematic sectional view through a sheet-fed rotary printing press having a quality control device,

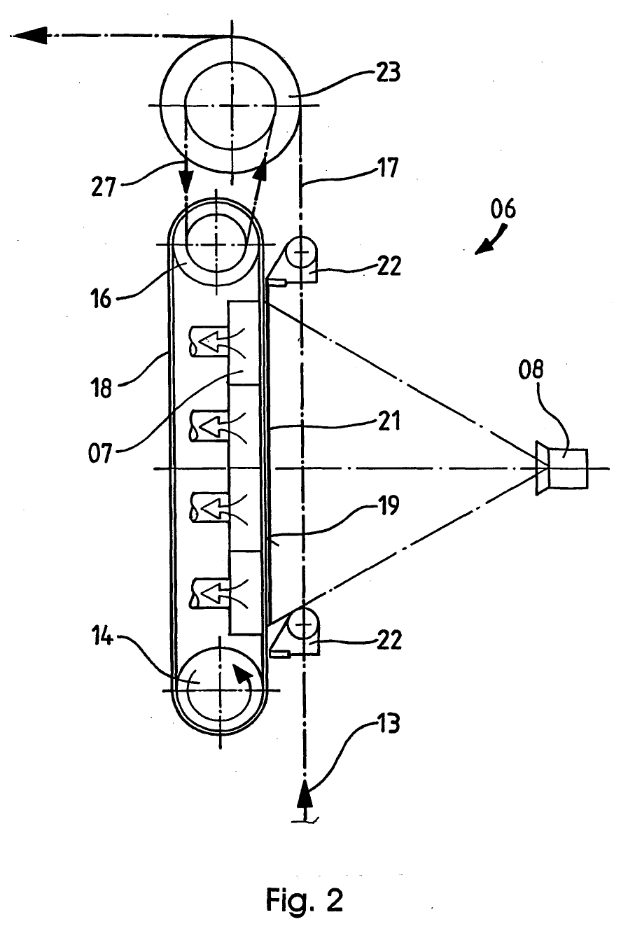

FIGS. 2 to 4, exemplary embodiments of the suction box and the belt of the quality control device.

A schematic sectional view through a sheet-fed rotary printing press having a quality control device is shown in FIG. 1. A sheet feeder of the press is not represented here; the structure of the printing group with inking systems 01 and plate cylinders 02, several of which are arranged on a collecting cylinder 03, is known per se and need not be described in greater detail here. Finished sheets, imprinted on both sides, are taken over by a conveying track 04, which has a plurality of chain gripper systems 22 guided on an endless chain, for example grippers 22. The sheets are conducted on the grippers 22 through a quality control device 06, which includes a suction box 07, which is connected to a partial vacuum source, not represented, as well as a CCD camera 08, whose field of view is directed onto the suction surface of the suction box 07. The CCD camera 08 is connected with an electronic evaluation device, not represented, which performs a comparison of the images obtained by the CCD camera 08 with a preselected print image to be obtained, and which decides for each detected sheet whether or not it corresponds to the print image to be obtained. A sheet delivery device 09 is arranged on the conveying track 04 following the quality control device 06 and has two stacks 12, for example two delivery stacks 12 for usable sheets, and one stack 11 for wasted sheets, for example a wasted sheet stack 11. Depending on the result provided by the evaluation device, a sheet is deposited either on one of the delivery stacks 12 for usable sheets, or on the wasted sheet stack 11.

FIG. 2 shows a first exemplary embodiment of the suction box 07 of the quality control device 06 and of the components surrounding it. Two guide rollers 14, 16 are rotatably seated on a frame (not represented) upstream, or downstream, viewed in the sheet conveying direction 13, of the suction box 07, which frame is fixedly connected with the guide rails (not represented) of a conveyor chain 17 of the conveying track 04. A flexible endless belt 18 has been looped around the guide rollers 14, 16 and is kept under tension by the guide rollers 14, 16. It extends over a suction surface 19 of the suction box 07, which is covered by a sheet 21 in FIG. 2, as well as over its back. The extension of the suction surface 19 corresponds to the largest sheet format to be imprinted in the sheet-fed rotary printing press. A plurality of suction lines connected to the side of the suction box 07 are connected with a suction air fan used as a partial vacuum source.

The belt 18 consists of a loose woven material, which is easily permeable to air, or any arbitrary flat material with punched-in or cut-in openings.

Grippers 22 are arranged on the conveyor chain 17 at a distance which is slightly larger than the largest sheet format to be imprinted. FIG. 2 shows a chain wheel 23 which is connected, fixed against relative rotation, to the guide roller 16 by means of a drive mechanism 27, for example a chain or toothed belt drive mechanism 27, and is in engagement with the conveyor chain 17 and in this way converts a translatory movement of the conveyor chain 17 into a rotatory movement of the guide roller 16. A corresponding chain wheel for engagement with a second conveyor chain of the conveying track 04 is provided on the front face of the guide roller 16 in FIG. 2 facing the viewer; however, this chain wheel, as well as the associated chain, have been omitted for reasons of clarity.

The pitch circle diameter of the chain wheel 23, the transmission ratio of the drive mechanism 27, the thickness of the belt 18, as well as the exterior diameter of the guide roller 16 are dimensioned in such a way that the surface of the belt 18 moves at exactly the same speed as a sheet 21 conveyed by the conveyor chain 17 by means of grippers 22. When a sheet 21 to be checked passes the quality control device 06, the sheet 21 is pressed against the surface of the belt 18 by an air flow directed onto the suction surface 19. Because of the vertically installed position of the suction box 07, the sheet 21 hangs smoothly downward under its own weight at this time and therefore is laid smoothly and free of creases onto the surface of the belt 18. When the sheet 21 reaches the position represented in FIG. 2, in which the sheet 21 lies flat on the suction surface 18 with its entire surface, the CCD camera 08, which is arranged facing the suction surface 19, generates an image of the sheet 21. A flash is usefully employed for producing the image, so that it is not necessary to slow down the movement of the sheet 21 for creating the image. In the time the sheet 21 needs for being conveyed from the quality control device 06 to the delivery stack 12, a check is made by means of the (not represented) image evaluation device to determine whether this is a faultless or a faulty sheet 21, so that it can be deposited on the stack 12 or 11 of the sheet delivery device 09 provided for this.

In case sheets 21 made of a very soft material, which therefore tend to fall into folds, are to be processed, it can be useful for the belt 18 to move at a slightly slower speed than the conveyor chain 17, or the gripper 22. It is possible in this way for a sheet 21 to be stretched flat to a certain extent, even if it already rests partially or completely on the belt 18. Such a speed ratio can be achieved in a simple manner if the pitch circle diameter of the chain wheel 23 is appropriately increased. A comparative result can of course also be obtained if the total transmission ratio of exactly 1 is displaced by changing the transmission of the drive mechanism 27, changing the thickness of the belt 18, or changing the diameter of the guide roller 16 to a total transmission ratio close to 1.

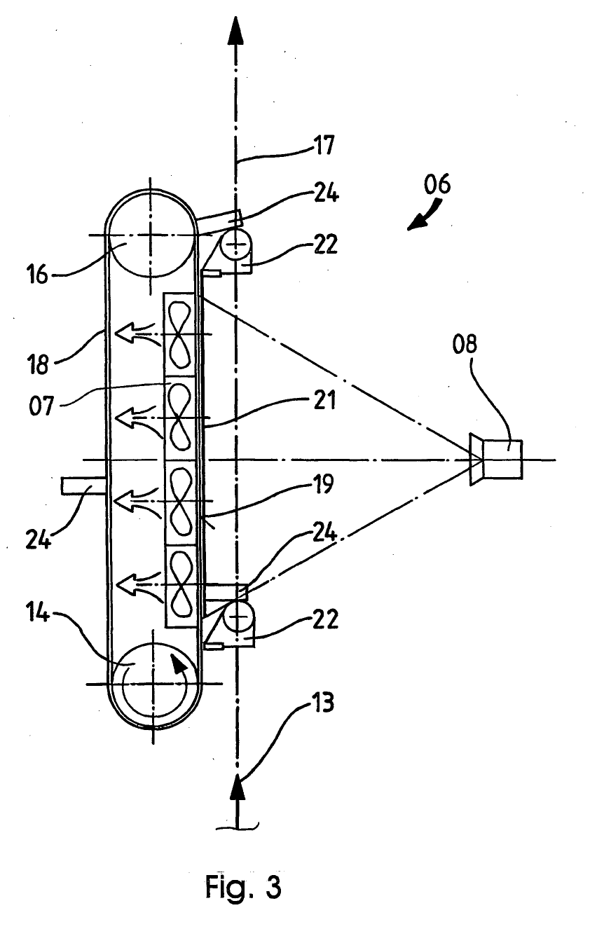

FIG. 3 shows a modification of the exemplary embodiment in FIG. 2, wherein a direct coupling of the guide rollers 14, 16 to the conveyor chain 17 has been omitted. Both guide rollers 14, 16 rotate freely; the driving of the belt 18 is achieved by means of carriers 24, which are respectively arranged in pairs at the lateral edges of the belt 18 and project into the track of the grippers 22, so that they are caught by a front edge of a gripper 22 and are pushed.

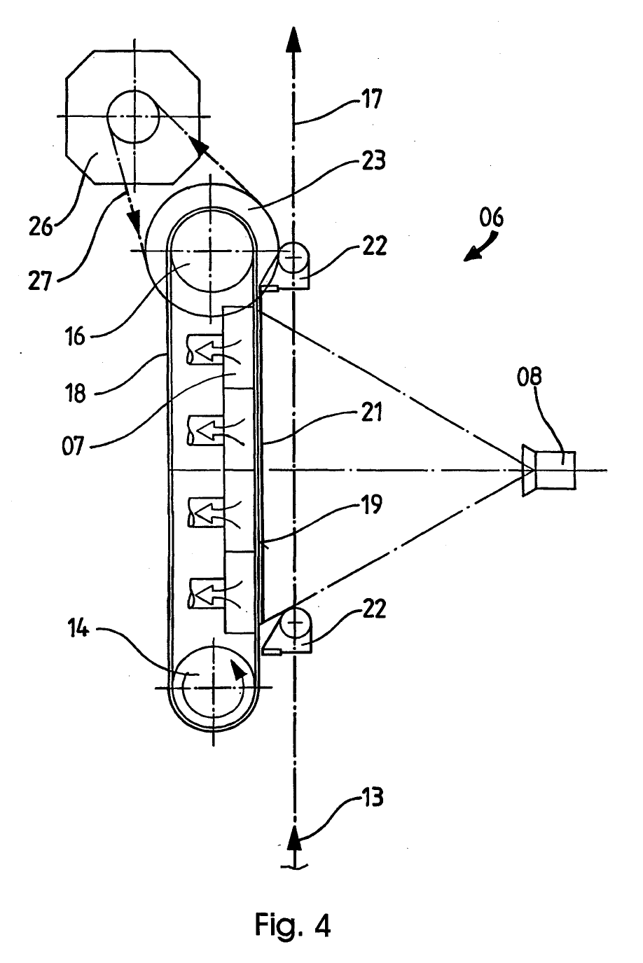

No mechanical coupling between the conveyor chain 17 and the belt 18 is provided in the exemplary embodiment of FIG. 4. Instead, the guide roller 16 has it own motor 26, which causes the rotation of the guide roller 16 at a regulated speed. This type of a drive mechanism permits an increased amount of flexibility since, depending on the type of control of the motor 26, the belt 18 can be operated at the exact speed of the grippers 22, or at a slightly reduced speed, which permits the tensing of the sheet 21, as described above.

With this exemplary embodiment (FIG. 4) it is also advantageously conceivable to equip each of the grippers 22 with force sensors for measuring a force exerted on a sheet 21, and to regulate the speed of the motor 26 by means of a control circuit (not represented) in such a way that it slightly falls below a threshold value of this force. This threshold value is the force needed for displacing a sheet 21, which rests correctly and without folds on the belt 18, on the belt 18. This force is a function of the size of the contact surface between the sheet 21 and the belt 18, and therefore in a fixedly defined and experimentally determinable manner of the position of the gripper 22. If a sheet 21 is placed on the belt 18 and forms folds, the surface on which it must be displaced to straighten out the fold is less than the total contact surface with the belt 18. In this way the force regulation causes these possible folds to be straightened out, but without the entire surface of the sheets 21 being displaced on the belt 18.

List of Reference Symbols

01 Inking system

02 Plate cylinder

03 Collection cylinder

04 Conveying track

05 -

06 Quality control device

07 Suction box

08 CCD camera

09 Sheet feeder

10 -

11 Stack, wasted sheet stack

12 Stack, delivery stack

13 Sheet conveying direction

14 Guide roller

15 -

16 Guide roller

17 Conveyor chain

18 Belt

19 Suction surface

20 -

21 Sheet

22 Chain gripper system, gripper

23 Chain wheel

24 Carrier

25 -

26 Motor

27 Drive mechanism, chain or toothed belt drive mechanism

1. A device (06) for quality control of an imprinted sheet (21), having a movable gripper (22) for pulling the sheet (21) and a CCD camera (08), characterized in that in addition a belt (18), which is movable in the sheet conveying direction (13) of the sheet (21), is arranged, and that the belt (18) is driven by its own motor (26).

2. A device (06) for quality control of an imprinted sheet (21), having a movable gripper (22) for pulling the sheet (21) and a CCD camera (08), characterized in that in addition a belt (18), which is movable in the sheet conveying direction (13) of the sheet (21), is arranged, and that the sheet conveying direction (13) of the sheet (21) is vertical.

3. The device in accordance with claim 1 or 2, characterized in that the belt (18) can be moved over a suction surface (19) of a suction box (07).

4. The device in accordance with claim 1 or 2, characterized in that the CCD camera (08) is a planar camera.

5. The device in accordance with claim 1 or 2, characterized in that the belt (18) is driven at the same speed as the gripper (22), or at a slightly slower speed.

6. The device in accordance with claim 1 or 2, characterized in that the belt (18) is an endless belt which, guided by means of two guide rollers (14, 16), is looped around the suction box (07).

7. The device in accordance with claim 2, characterized in that the gripper (22) is guided on a conveyor chain (17), and that the belt (17) is driven via the conveyor chain (17).

8. The device in accordance with claim 7, characterized in that a chain wheel (23) which is connected by means of a drive mechanism (27) with one of the guide rollers (16) meshes with the conveyor chain (17).

9. The device in accordance with claim 8, characterized in that the pitch circle diameter of the chain wheel (23), the transmission ratio of the drive mechanism (27), the thickness of the belt (18), as well as the exterior diameter of the guide roller (16) are dimensioned in such a way that the speed of the belt (18) corresponds to or is slightly less than the track speed of the gripper (22).

10. The device in accordance with claim 1 or 2, characterized in that the belt (18) supports carriers (24) which are in engagement with the track of the gripper (22).

11. The device in accordance with claim 2, characterized in that the belt (18) is driven by its own motor (26).

12. The device in accordance with claim 1 or 11, characterized in that the drive motor control device is arranged for regulating the motor (26) to a speed of the belt (18) which corresponds to the track speed of the gripper (22), or is slightly less.

13. The device in accordance with claim 12, characterized in that the control device regulates the speed of the belt (18) in such a way that a threshold value of the pulling force exerted by the gripper (22) on the sheet (21) is not exceeded.

14. The device in accordance with one of the preceding claims, characterized in that the sheet conveying direction (13) of the sheet (21) is vertical.

15. The device in accordance with one of the preceding claims, characterized in that it is arranged between the printing group and sheet feeder (09) of a sheet-fed rotary printing press.
